(19) United States
(12) Patent Application Publication
(10) Pub. No.: US 2009/0265091 A1
(43) Pub. Date: Oct. 22, 2009

(54) METHOD AND APPARATUS UTILIZING BOTH STATISTICAL AND REAL TIME DATA FOR A VEHICLE NAVIGATION SYSTEM

(75) Inventors: Kimiyoshi Machii, Novi, MI (US); Sadanori Horiguchi, Novi, MI (US)

Correspondence Address: GIFFORD, KRASS, SPRINKLE,ANDERSON & CITKOWSKI, P.C, PO BOX 7021, TROY, MI, 48007-7021, US

(73) Assignee: Xanavi Informatics Corporation, Kanagawa-Ken (JP)

(21) Appl. No.: 12/103,859

(22) Filed: Apr. 16, 2008

(51) Int. Cl. G01C 21/36

(52) U.S. Cl. 701/200

(57) ABSTRACT

A method for determining a preferred route of road links between an origin and a destination in a vehicle navigation system. A boundary is established the origin and a destination and real time road link data is acquired for road links between the origin and the boundary. Similarly, road link data from a statistical database is retrieved from a road link database for road links between the boundary and the destination. The preferred route between the origin and the destination is then calculated as a function of both said real time road link data and statistical road link data and the calculated route is displayed on a screen.

### BACKGROUND OF THE INVENTION

I. Field of the Invention

The present invention relates generally to automotive navigation systems and, more particularly, to such a navigation system which utilizes both statistical road link data and real time road link data to calculate a preferred route between an origin and a destination.

II. Description of Related Art

Automotive navigation systems have become increasingly prevalent in automotive vehicles. Such navigation systems typically include a display screen mounted in the vehicle in a position visible to the driver A road map is displayed on the screen from an internally contained map database and, by utilizing GPS to determine the position of the vehicle, also displays the position of the vehicle on the screen.

As the automotive navigation systems have become more prevalent, statistical databases containing historical speeds for road links in the database have become available. These statistical databases contain information for the various road links in the database, i.e. a section of road extending between two nodes. The information contained in these statistical databases, furthermore, may also contain not only vehicle speed information for each road link in the statistical database, but also traffic information for the road links as a function of the Lime of day. For example, traffic speeds for certain road links may be significantly slower during the so-called morning and afternoon rush hours, whereas the traffic speeds for these road links increases significantly at other times of the day.

Consequently, in order for the navigation system to calculate a preferred route, typically the fastest route, between an origin, usually the position of the vehicle, and a destination, a processor accesses the statistical database and calculates the preferred route using any conventional route calculation algorithm, such as Dijkstra's algorithm. The calculated route is then displayed on the screen visible to the vehicle driver.

A primary disadvantage of these previously known navigation systems which utilize statistical traffic flow data for the road links when calculating the preferred or fastest route from the origin and to the destination is that local traffic events may have a significant impact upon the traffic flow for one or more road links in the calculated route. For example, a traffic event, such as a traffic accident on one of the road links along the calculated route, may sufficiently slow the traffic along that road link so that a recalculated route which avoids the road link with the traffic event would result in a shorter travel time between the origin and the destination.

Currently, many major metropolitan areas include the wireless transmission of real time traffic flow data for various road links within the metropolitan area. These transmissions of local traffic flow for the road links oftentimes include data relating to not only the time of the traffic flow or traffic event occurring upon any particular road link or road links, but also the time of that particular report. Such local traffic data may be obtained in any of a number of fashions, such as by probe cars, highway mounted cameras, and the like.

Previously, automotive navigation systems have not effectively utilized the local traffic flow data received in the calculation by the navigation system of the preferred or fastest route from the origin, i.e. typically the position of the automotive vehicle, and to the destination. Instead, such local traffic data was utilized by the navigation system, if at all, only in a haphazard fashion.

### SUMMARY OF THE PRESENT INVENTION

The present invention provides both a method and apparatus for determining a preferred route, typically the fastest route, of road links between an origin and a destination in a vehicle navigation system.

When calculating a route, typically the position of the car constitutes the origin of the route. That origin, in turn, is typically determined through a GPS system.

Conversely, in order for the navigation system to compute the preferred or fastest route between the origin and destination, a destination must be inputted by the user in some fashion. Any conventional means, such as a keyboard, touch screen input, joystick or the like may be utilized to input the destination for the vehicle trip.

The vehicle navigation system typically comprises a processor which is capable of accessing not only a map database, but also a statistical database containing statistical or historical data on traffic flow patterns for multiple road links. Both the map database as well as the statistical road link database are stored in the navigation system on a hard drive or other means of persist memory.

The navigation system also includes a wireless radio which receives real time road link data, if available, for the area surrounding the position of the vehicle. Such real time road link data may be transmitted in any fashion, such as by radio, cell phone, Wi-Fi, and/or the like, which is received by the navigation system. Upon receipt, the navigation system stores the real time local data in memory.

After the user inputs the destination into the navigation system, the navigation system establishes a boundary between the origin and the destination. That boundary may be simply a distance boundary extending outwardly from the origin, or may constitute a calculated estimated time boundary which will vary depending upon the road links between the origin and the boundary.

The navigation system then calculates the preferred route between the origin and the destination by utilizing the real time local traffic road link data between the origin and the boundary, if available, and, conversely, utilizing the statistical road link database for road links between the boundary and the destination. In this fashion, enhanced route calculations and route predictions are performed which more accurately account for real time local traffic events and real time road link traffic flow data locally around the vehicle thus resulting in overall increased accuracy for the route calculation and route predictions.

The present invention also provides enhanced route calculations utilizing interpretation and also filtering and processing of real time data the receipt of which by the navigation system is delayed.

### BRIEF DESCRIPTION OF THE DRAWING

A better understanding of the present invention may be had upon reference to the following detailed description when read in conjunction with the accompanying drawing, wherein like reference characters refer to like parts throughout the several views, and in which:

FIG. 1 is a block diagrammatic view illustrating a preferred system configuration of the present invention;

FIG. 2 is a block diagrammatic view of a preferred software configuration;

FIG. 3 is a block diagrammatic view of a traffic data provider;

FIG. 4 is a diagram of the configuration of the statistical road link traffic flow data;

FIG. 5 is an exemplary data configuration of the real time road link traffic flow data;

FIG. 6 is a flowchart illustrating the process flow of the route calculation;

FIG. 7 is a flowchart illustrating the adjustment of the real time traffic flow data through interpolation;

FIG. 8 is a flowchart illustrating the determination of whether or not to disregard certain real time data;

FIG. 9 is an exemplary road link map;

FIG. 10 is a flowchart illustrating the interpolation of real time traffic data;

FIG. 11 is a road link map illustrating a boundary set as a function of distance;

FIG. 12 is a view similar to FIG. 11 but illustrating the boundary set as a function of time;

FIG. 13 is a flowchart illustrating the adjustment for time lag between the occurrence and receipt of real time traffic flow data;

FIG. 14 is a screen shot illustrating the user input to establish the parameters for the boundary; and

FIG. 15 is a diagrammatic view illustrating pattern matching for real time road link traffic flow data.

### DETAILED DESCRIPTION OF A PREFERRED EMBODIMENT OF THE PRESENT INVENTION

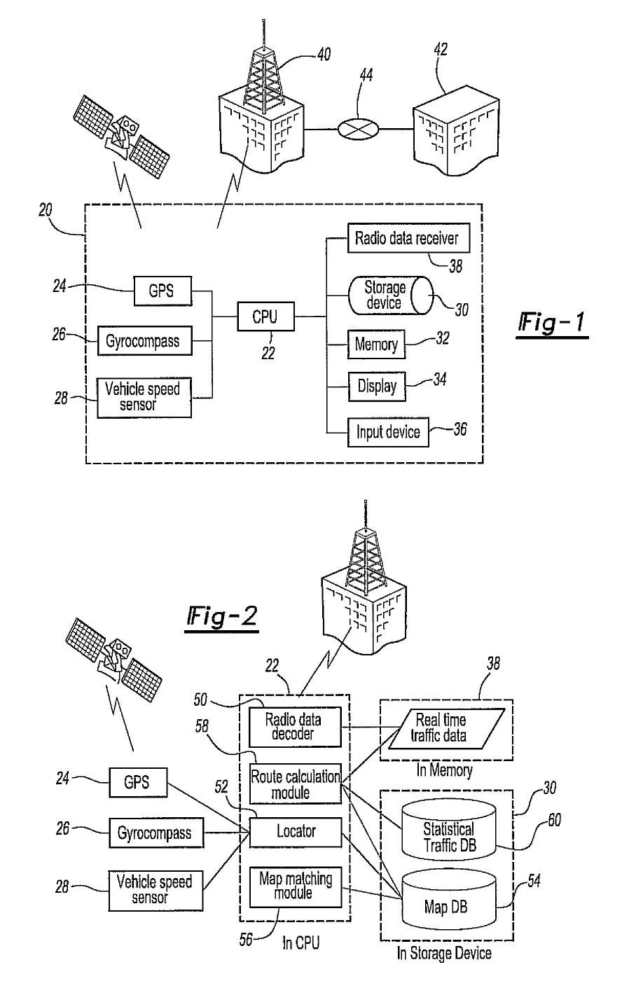

With reference first to FIG. 1, a block diagrammatic view of a navigation system 20 of the present invention is shown. The navigation system 20 includes a processor 22 which is typically a programmed microprocessor. The processor 22 also receives different data from different inputs.

Specifically, the processor 22 receives the position of the vehicle from a GPS module 24. The processor 22 also optionally receives inputs from a gyrocompass 26 indicative of the direction of travel of the vehicle as well as the speed of the vehicle from a speed sensor 28.

The processor 22 communicates through a bus with a storage device 30. The storage device 30, which may be a hard drive or other persistent memory means, contains both a map database as well as a statistical or historical road link traffic flow database as well as other information. Random access memory 32 is also accessible by the CPU 22. This memory 32 may contain not only temporary calculations from the CPU 22, but also other memory which controls the overall operation of the navigation system.

The CPU 22 also controls the operation of a display screen 34. Typically, the processor 22 displays the map data as well as the position of the vehicle on the display screen 34.

The display screen 34 may also comprise a touch screen so that information, e.g. the desired destination of the vehicle, may be inputted to the processor 22. Optionally, or in addition, an input device 36, such as a keypad, a mouse, joystick, etc., may also provide input information to the processor 22.

The navigation system 20 includes a radio data receiver 38 which receives wireless communication from a radio station 40. The radio station 40, in turn, receives local real time traffic flow data, and also information relating to traffic events, e.g. accidents, lane closures, etc., from a traffic data provider 42. The traffic data flow provider may provide this information to the radio station 40 through a network 44.

The wireless radio data receiver 38 thus receives real time local traffic flow data 38 and provides this information to the processor 22. However, as a practical matter, there may be some delay between the actual acquisition of the real time traffic data flow or traffic event by the traffic data provider 42 and the receipt of that information by the navigation system 22. This time lag or delay in receiving the real time information is addressed hereinafter.

With reference now to FIG. 2, a software configuration for the navigation system 20 is shown. The processor 22 is programmed under software control to include a radio data decoder 50 which receives signals from the radio receiver 38 and decodes the received real time into a format which can be utilized by the processor 22.

The processor 22 also includes a locator algorithm 52 which locates the position of the vehicle from inputs from the GPS module 24, gyrocompass 26 and vehicle speed sensor, as well as from a map database 54 contained in the storage device 30. The storage device 30, furthermore, may be a CD, DVD, HDD or other means for persistent memory. The locator also cooperates with a map matching module 56 to properly position the vehicle on the map displayed on the display 34 (FIG. 1).

A route calculation module 58 accesses not only the real time local data decoded by the radio data decoder 50, but also statistical or historical road link traffic flow data from a statistical database 60 also contained in the storage device 30. The route calculation module may use any conventional calculation algorithm, such as Dijkstra's algorithm, to calculate a preferred route between the origin, typically the position of the vehicle, and a destination. Usually, but not always, the preferred route is the quickest route between the origin and the destination. Other routes, e.g. a scenic route between the origin and destination, may alternatively form the preferred route between the origin and the destination.

With reference now to FIG. 3, a diagrammatic view of a real time road link traffic data flow provider is shown. The traffic provider 42 receives real time data from a variety of different inputs, such as road sensors 62, probe cars 64 and highway cameras 66. The traffic provider 42 includes a real time data creation algorithm 68 which, by utilizing the inputs from the sensors 62, 64 and 66, creates a real time road link traffic flow database 70. The real time data in the database 70 then communicates through a communication apparatus 74, such as a modem, to the network 44. From the network 44, the real time traffic flow data is then transmitted by the radio station 40 (FIG. 1).

The real time data collected by the traffic provider 42 is processed by a statistical data creation module 76 to create a statistical traffic flow database for the road links which is then stored in a statistical traffic flow database 78. The information from that statistical traffic flow database 78 may be ultimately distributed to update the navigation systems 20 by the creation of the appropriate CD, DVD or the like as shown at 80.

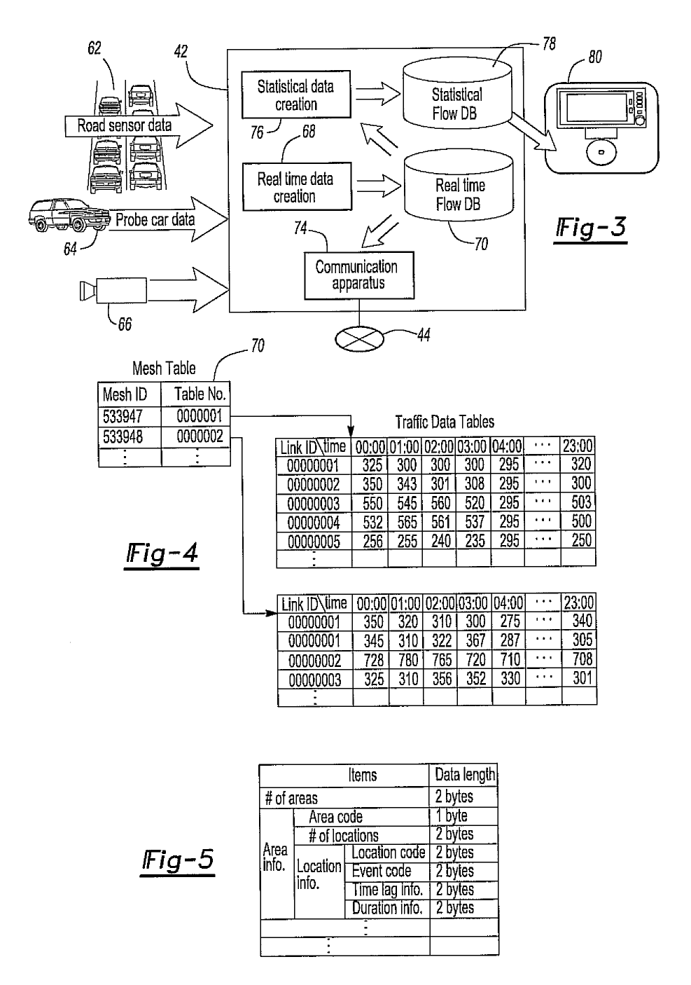

The actual format in which the navigation system 22 maintains the statistical traffic flow database 60 may vary. However, FIG. 4 illustrates an exemplary format for the statistical traffic flow database having a mesh table 70 in which the entire map is divided into a number of different meshes, each having a different mesh ID. Each mesh, furthermore, includes a number of different road links and each road link is identified by a unique number. Consequently, a road link identified by the road link number and the mesh number represents a unique road link in the overall map database. Furthermore, the traffic flow data for each road link may also be contained as a function of time, e.g. in one hour segments as shown in FIG. 4.

The data format for the real time traffic flow data, however, varies from the statistical data since, unlike the statistical traffic flow data, the real time data includes only temporal data. An example of the data in the real time database is shown in FIG. 5 in which the overall map is divided into a number of different areas and different areas assigned a different area code as well as a number of different locations within that code for which real time data may be or is available. The real time database also includes a location code including the spot of a traffic event, an event code representative of the type of traffic event, e.g. lane closure or accident. The location information also includes time lag information indicating the elapsed time between the actual traffic event and the receipt of the traffic event by the navigation system, as well as information relating to the duration of the traffic event. As shown in FIG. 3, this information is stored in the real time road link traffic flow database 70.

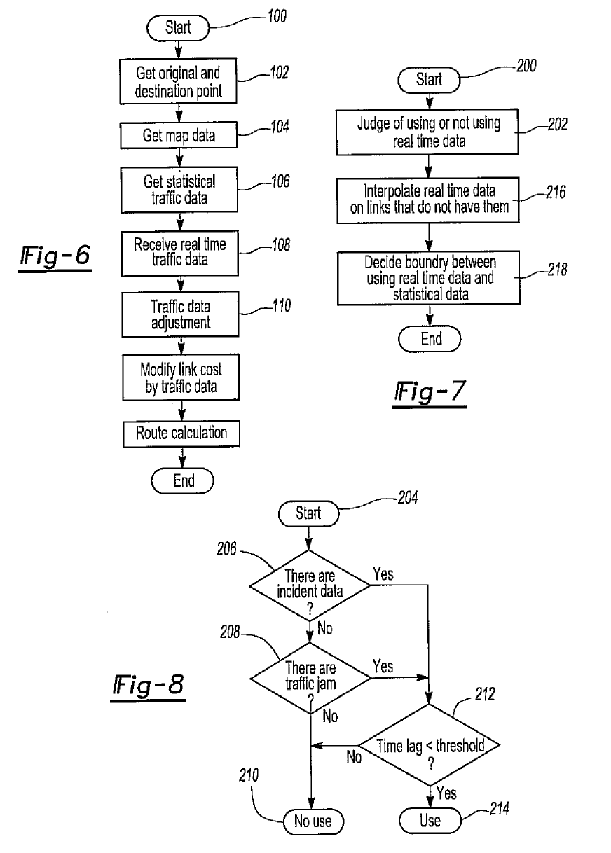

With reference now to FIG. 6, a general flowchart is illustrated showing the overall operation of the present invention in which both statistical as well as real time road link traffic flow data is utilized to calculate the route between the origin and the destination. The algorithm starts at step 100 and then proceeds to step 102 where the processor 22 acquires both the origin as well as the destination. The origin is determined typically by the current position of the vehicle by the locator module 52 (52) while the destination is entered by the user, typically through a touch screen 34 or other input device 36 (see FIG. 1). Step 102 then proceeds to step 104.

At step 104, the processor 22 accesses the map data from the map data database 54 (FIG. 2). Step 104 then proceeds to step 106 where the processor 22 accesses the statistical or historical road link traffic flow data from the statistical traffic flow database 60 (FIG. 2) in the format illustrated in FIG. 4. Step 106 then proceeds to step 108.

At step 108, the processor receives real time road link traffic flow data from the radio station 40 (FIG. 1) and stores this data in the real time traffic flow database 70 (FIG. 3). Step 108 then proceeds to step 110.

At step 110, the algorithm illustrated in FIG. 7 is executed to set the boundary between real time data and statistical data for route calculations. After the initiation of the subroutine at step 200, step 200 proceeds to step 202 which determines whether or not the real time data received by the navigation system should be used at all. For example, with reference to FIG. 8, in determining if the real time data should be disregarded because too much time has elapsed between the traffic event and the receipt of the information or data by the navigation system, after the initiation of the routine at step 204, step 204 proceeds to step 206 where the algorithm determines whether or not real time traffic incident data has been received by the navigation system. If not, step 206 proceeds to step 208 which determines if there are any traffic jams. If not, step 208 proceeds to step 210 and ultimately back to step 202 (FIG. 7). In this event, since there are no traffic events or traffic jams, there simply is no real time traffic data of interest to be used in the route calculation.

Conversely, if the real time traffic data includes a traffic event or incident step 206 instead branches to step 212. Similarly, if there are traffic jams, step 208 also branches to step 212. At step 212, the time lag between the traffic incident or the traffic jam is compared to a threshold. If the time lag is less than the threshold, indicative that the real time data is sufficiently recent to be useful in the route calculation, step 212 branches to step 214 indicative that the real time data should be used in the route calculation. Step 214 then branches back to step 202. However, if the time lag is greater than the threshold, indicating that the real time data is too old to be useful in the route calculation, step 212 instead branches to step 210 where the real time data is simply disregarded.

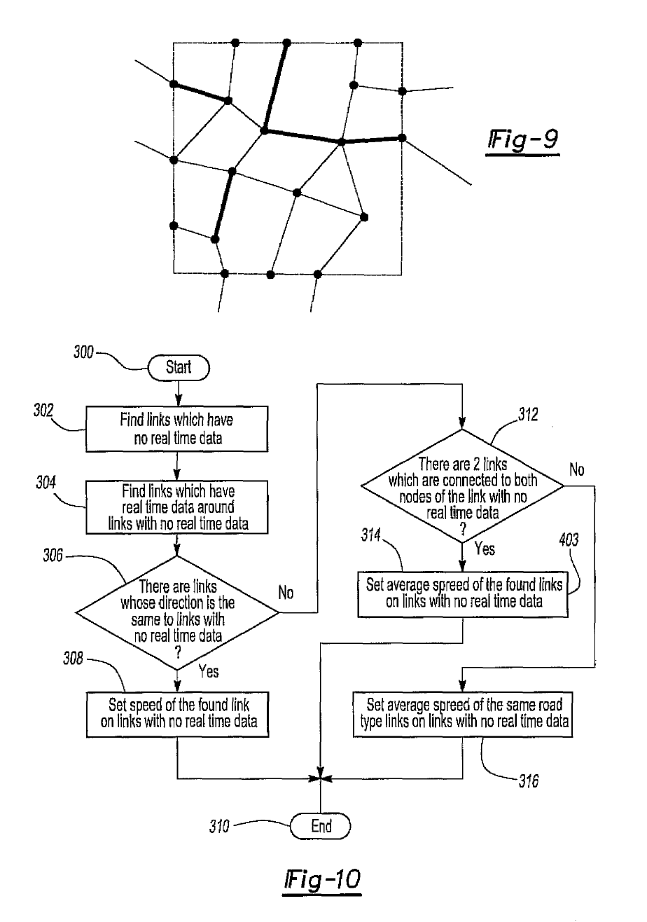

Referring again to FIG. 7, after the execution of step 202 and the determination of whether or not the real time data should be either disregarded or utilized in the route calculation, step 202 proceeds to step 216. As a practical matter, real time data does not exist on all of the road links of interest in the route calculation. Consequently, step 216 interpolates real time data for road links which do not have data but which do have real time data for adjacent road links. For example, with reference to FIG. 9, assuming that road links 910 and 911 include real time road link data, but that road link 901 does not, step 216 (FIG. 7) will interpolate or average the speed between the road links 910 and 911 for which real time data exists, and utilize that average speed as the speed for the road link 901 for which no real time data exists.

Similarly, the traffic for road link 903, for which no real time data exists, may be determined through interpolation by the average of the traffic speeds for the road links 912 and 913. In this example, road links 912 and 913 both contain real time traffic flow data.

Similarly, assuming that real time traffic flow data exists for road link 911, the traffic flow on road link 902 may be interpolated by the real time traffic flow data on road link 911. This assumes that the road links 902 and 911 are of the same general road types and that the road links 902 and 911 extend generally in the same direction.

With reference now to FIG. 10, a flowchart illustrating the interpolation of the road links which have no real time data by adjacent or proximate road links which do have real time data is shown. After initiation of the algorithm at step 300, step 300 proceeds to step 302 where the algorithm identifies links along the calculated route which have no real time data. Step 302 then proceeds to step 304 which identifies road links around or proximate the road links identified in step 302 but in which real time data for the road links exists. Step 304 then proceeds to step 306.

At step 306, the algorithm determines if there are road links having real time data which are in the same direction as road links along the route for which there are no real time data. If so, step 306 proceeds to step 308 which then sets the speed of the road link without real time data to the same speed as the identified road link with real time data. This assumes, of course, that the two road links are of the same general road type. Step 308 then exits the algorithm at step 310.

Conversely, if there are no road links with real time data in the same direction as the road link along the route without real time data, step 306 instead branches to step 312 which determines if there are two links that are connected to the nodes of the road link without real time data along the route. If so, step 312 proceeds to step 314 where the average speed of the road link without real time data is set to the average speed of the two adjacent road links with real time data. This will correspond, for example, to setting the road link 901 to the average of road links 910 and 911 in FIG. 9. Step 314 then exits the algorithm at step 310.

Conversely, if there are not two road links with real time data connected to the road link without real time data along the route, step 312 instead branches to step 316. At step 316, the average speed of the same type of road for the road link without real time data is determined and established as the traffic flow data for the road link without traffic flow data. Step 316 then proceeds to step 310.

With reference again to FIG. 7, after interpolation of the real time data at step 216 utilizing the algorithm of FIG. 10 has been performed, step 216 proceeds to step 218. Step 218 determines the boundary between the origin and the destination. Once the boundary is set, real time data, or real time data achieved through interpolation, will be utilized for the road links between the origin and the boundary. Conversely, statistical traffic flow data, actual or interpolated, will be utilized for the road links along the calculated route between the boundary and the destination. In this fashion, real time traffic flow data will be used in the route calculation for those road links nearer to the vehicle position whereas only statistical road link traffic flow information from the statistical traffic database 60 (FIG. 2) will be used for those areas along the calculated route that are further away from the origin.

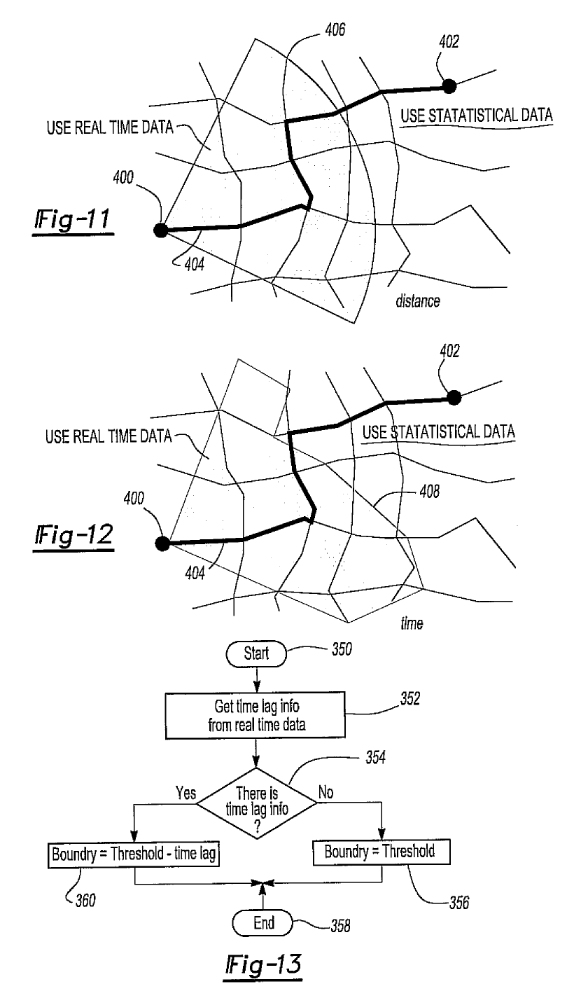

For example, with reference now to FIG. 11, an origin 400, typically the current position of the vehicle, is illustrated as well as an inputted destination 402. The navigation system, using conventional route calculating methods, then calculates a route 404 from the origin 400 and to the destination 402.

Step 218 (FIG. 7) also calculates a boundary 406 which is a defined distance from the origin 400. As such, the boundary 406 is in the form of a semicircle with the center of the semicircle centered on the origin 400. With the boundary 406 established as shown in FIG. 11, only real time road link traffic flow data, including real time data interpolated from the actual real time data, will be used for the route calculation between the origin and the boundary 406. Conversely, statistical or historical traffic flow data will be used for route calculations between the boundary 406 and the destination 402.

With reference now to FIG. 12, a boundary 408 may also be established that is spaced from the origin not by a preset distance, but rather by an estimated time of travel between the origin 400 and the boundary 408. Consequently, the boundary 408, unlike the boundary 406, does not necessarily extend in a semicircle centered on the origin 400. Rather, the boundary 408 will typically have a generally irregular shape depending upon the road links.

Otherwise, the route calculations for the route 404 illustrated in FIG. 12 will be the same as the route 404 in FIG. 11. Specifically, the route calculations will utilize real time data, or interpolated real time data, for road links between the origin 400 and the boundary 48. Conversely, statistical data will be utilized for road links between the boundary 408 and the destination 402. The link cost is then modified at step 111 (FIG. 6) and the route calculated at step 113.

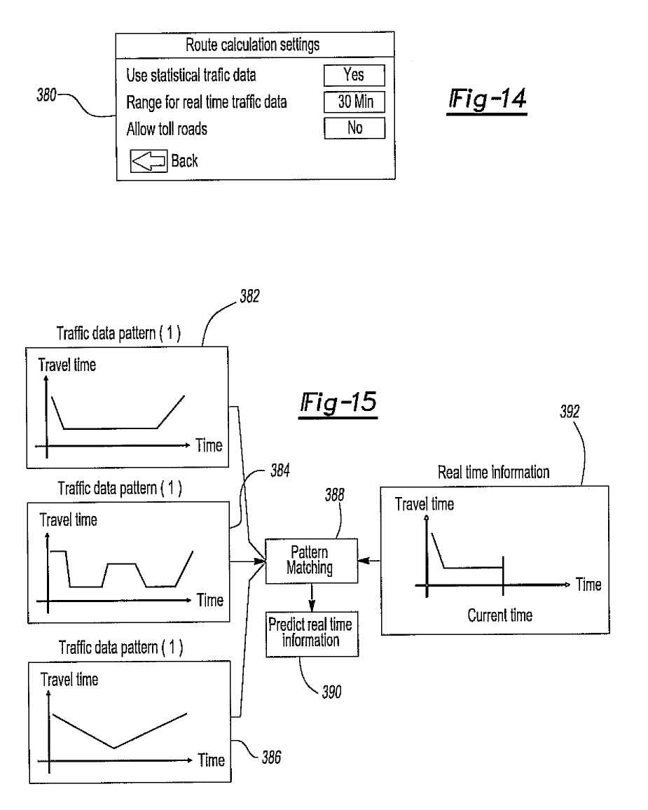

With reference now to FIG. 13, where the boundary 408 (FIG. 12) is calculated as a function of time between the origin 400 and the boundary 408, the time lag or time delay between the actual traffic flow event and the receipt of that traffic flow data by the navigation system and the calculation of the route 404 using the real time traffic flow data will vary as a function of that time lag. FIG. 13, however, illustrates an algorithm to compensate for that time lag.

More specifically, the algorithm of FIG. 13 begins at step 350 and then proceeds to step 352 where the algorithm obtains the time lag information from the real time data received by the navigation system. Step 352 then proceeds to step 354.

Step 354 then determines if there is a time lag for the received info. If not, step 354 proceeds to step 356 where the boundary is set to the threshold and then to step 358 which terminates the algorithm. Conversely, if there is a time lag between the traffic event and the receipt of the information, step 354 instead branches to step 360 where the boundary 408 is set to the threshold less the time lag. In this fashion, the threshold 408 is adjusted to compensate for any time lag of the real time data.

The actual boundary between the origin and the destination, whether it be the boundary 406 (FIG. 11) which is a distance between the origin 400 and the boundary 408, or the time boundary 408 (FIG. 12) between the origin 400 and the boundary 408 may be preestablished and fixed by the navigation system. However, as shown in FIG. 14, a user screen 380 may also be presented to the vehicle occupant which enables the vehicle occupant not only to select between the distance boundary 406 (FIG. 11) or the time boundary 408 (FIG. 12), but also to adjust both the distance and/or time lag between the origin and the boundaries.

With reference now to FIG. 15, many different road links will exhibit different patterns of traffic flow data depending upon the time of day. For example, traffic flow data for a particular road link may be significantly slower during the morning and afternoon rush hours, than at other times.

FIG. 15 illustrates three exemplary traffic flow patterns 382, 384 and 386 for a road link. A pattern matching algorithm 388 utilizing the traffic pattern for the road link may then predict the real time traffic flow for the road link as shown in algorithm 390 and illustrated at box 392. Such pattern matching may further enhance the accuracy of the route calculations by the navigation system.

A primary advantage of the present invention is that the present invention utilizes the real time traffic flow data, including interpolated data, only for the road links between the origin, typically the position of the vehicle, and statistical road link traffic flow data between the boundary and the destination. In this fashion, real time road link traffic flow data, which has a much greater impact on road links soon to be traveled by the vehicle, is employed in the route calculations while statistical data is utilized for road links much further from the current position of the vehicle. This combination achieves more accurate route calculations than with the previous systems.

Having described our invention, many modifications thereto will become apparent to those skilled in the art to which it pertains without deviation from the spirit of the invention as defined by the scope of the appended claims.

We claim:

1. A method for determining a preferred route having a number of road links between an origin and a destination in a vehicular navigation system comprising the steps of:
establishing a boundary between the origin and the destination,
acquiring real time road link data, if available, for road links between the origin and said boundary,
retrieving from a database statistical road link data for road links between said boundary and the destination,
calculating the preferred route between the origin and the destination as a function of said real time road link data and said statistical road link data, and
displaying the preferred route.

2. The method as defined in claim 1 wherein said establishing step further comprises the step of setting a distance between the origin and the boundary.

3. The method as defined in claim 2 wherein said distance is user selectable.

4. The method as defined in claim 1 wherein said establishing step further comprises the step of setting a calculated travel time between the origin and the boundary.

5. The method as defined in claim 4 wherein said calculated travel time is user selectable.

6. The method as defined in claim 4 and further comprising the step of adjusting said calculated travel time to offset a time delay between the occurrence of a real time traffic event and the acquisition of the real time traffic event by the navigation system.

7. The method as defined in claim 1 and further comprising the step of disregarding real time road link data whenever a time lag between the occurrence to the real time road data and the acquisition of the real time traffic event by the navigation system exceeds a preset threshold.

8. The method as defined in claim 1 and further comprising the steps of:
identifying road links between the origin and the boundary having no real time data,
identifying road links having real time data in proximity to said road links without real time data,
approximating road link data for said road links without real time data by interpolating road link data from said proximate road links having road link data.

9. The method as defined in claim 1 and further comprising the step of adjusting selected real time road link data as a function of statistical patterns for said selected real time road links.

10. Apparatus for determining a preferred route having a number of road links between an origin and a destination in a vehicular navigation system comprising:
means for maintaining a statistical road link database,
means for acquiring real time road link data, if available, for road links between the origin and said boundary,
means for establishing a boundary between the origin and the destination,
means for retrieving road link data between said boundary and the destination from said statistical road link database,
a processor which calculates the preferred route between the origin and the destination as a function of said real time road link data and said statistical road link data, and
means for displaying the preferred route.

11. The apparatus as defined in claim 10 wherein said means for establishing further comprises means for setting a distance between the origin and the boundary.

12. The apparatus as defined in claim 11 wherein said distance is user selectable.

13. The apparatus as defined in claim 10 wherein said means for establishing further comprises means for setting a calculated travel time between the origin and the boundary.

14. The apparatus as defined in claim 13 wherein said calculated travel time is user selectable.

15. The apparatus as defined in claim 13 and further comprising means for adjusting said calculated travel time to offset a time delay between the occurrence of a real time traffic event and the acquisition of the real time traffic event by the navigation system.

16. The apparatus as defined in claim 10 and further comprising means for disregarding real time road link data whenever a time lag between the occurrence to the real time road data and the acquisition of the real time traffic event by the navigation system exceeds a preset threshold.

17. The apparatus as defined in claim 10 and further comprising:
means for identifying road links between the origin and the boundary having no real time data,
means for identifying road links having real time data in proximity to said road links without real time data,
means for approximating road link data for said road links without real time data by interpolating road link data from said proximate road links having road link data.

18. The apparatus as defined in claim 10 and further comprising means for adjusting selected real time road link data as a function of statistical patterns for said selected real time road links.
